(19) United States
(12) Patent Application Publication
(10) Pub. No.: US 2016/0283860 A1
(43) Pub. Date: Sep. 29, 2016

(54) Machine Learning to Recognize Key Moments in Audio and Video Calls

(71) Applicant: MICROSOFT TECHNOLOGY LICENSING, LLC, Redmond, WA (US)

(72) Inventors: James Edgar Pycock, Palo Alto, CA (US); Alan Wesley Peevers, Santa Cruz, CA (US)

(21) Appl. No.: 14/668,646

(22) Filed: Mar. 25, 2015

(51) Int. Cl. G06N 99/00

(52) U.S. Cl. CPC G06N 99/005

(57) ABSTRACT

Various embodiments provide an ability to automatically capture audio and/or video during a communication exchange between participants. At times, the automatic capture can be triggered when one or more characteristics are identified and/or observed during the communication exchange. In some cases, analyzing the communication exchange for characteristic(s) is based on previous input. Some embodiments train a machine-learning algorithm on desired characteristic(s) using multiple user-initiated video and/or audio clips. Alternately or additionally, some embodiments identify characteristic(s) in a communication exchange based on other properties not provided by user-input.

### BACKGROUND

Video and/or audio calls allow for real-time communication exchanges between participants who are remote from one another. This form of communicating enables the participants to rapidly exchange ideas and information, thus fostering a more collaborative and creative process. Further, video and audio each allow a person to convey emotions more succinctly than by text through the use of facial expressions, audio intonations, and so forth. However, one advantage to exchanging information via text is the persistent nature of the information. A video and/or audio call inherently leaves no persistent documentation that can be reviewed when the call is done. While video and/or audio can be recorded, often times a user may not activate the capture mechanism in time to record the exchanges that contain video and/or audio of interest. Further, recording a whole conversation can encompass a large amount of data, making it difficult to locate key points of interest.

### SUMMARY

This Summary is provided to introduce a selection of concepts in a simplified form that are further described below in the Detailed Description. This Summary is not intended to identify key features or essential features of the claimed subject matter.

Various embodiments provide an ability to automatically capture audio and/or video during a communication exchange between participants. At times, the automatic capture can be triggered when one or more characteristics are identified and/or observed during the communication exchange. In some cases, analyzing the communication exchange for characteristic(s) is based on training the analysis with previous input. Some embodiments train a machine-learning algorithm on desired characteristic(s) using multiple user-initiated video and/or audio clips. Alternately or additionally, some embodiments identify characteristic(s) in a communication exchange based on other properties not provided by user-input.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 is an illustration of an example implementation in accordance with one or more embodiments.

FIG. 3 is an illustration of an example implementation in accordance with one or more embodiments.

FIG. 4 is an illustration of an example implementation in accordance with one or more embodiments.

FIG. 5 is an illustration of an example implementation in accordance with one or more embodiments.

FIG. 6 is a flow diagram that describes steps in a method in accordance with one or more embodiments.

FIG. 7 is an illustration of an example implementation in accordance with one or more embodiments.

FIG. 8 is a flow diagram that describes steps in a method in accordance with one or more embodiments.

FIG. 9 illustrates various components of an example device that can be implemented as any type of computing device as described herein.

### DETAILED DESCRIPTION

Overview

Various embodiments provide an ability to automatically capture audio and/or video during a communication exchange between participants. At times, the automatic capture is triggered when one or more characteristics are identified and/or observed during the communication exchange. For example, multiple participants can engage in a video conference call via client software installed on their respective devices. In some cases, the client software analyzes portions of the video conference call to determine when to automatically capture portions of the video and/or audio. The analysis can be based on any suitable type of metric and/or information. Some embodiments base the analysis on previous user input, such as user-initiated video clips (i.e. video clips where capture is manually initiated by a user) to train a machine-learning algorithm. A machine-learning algorithm receives the multiple inputs, analyzes each input, and aggregates the results of the analysis as a way to learn characteristic(s) associated with points of interest in an exchange (i.e. video properties, content properties, audio properties, etc.). These aggregated results can then be used to identify and/or classify points of interest during a real-time communication exchange. When a point of interest has been identified, some embodiments trigger an automatic capture of the communication exchange around the point(s) of interest. Alternately or additionally, predefined properties can be used in conjunction with, or independent of, the learned characteristics to automatically trigger capture, as further described below.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

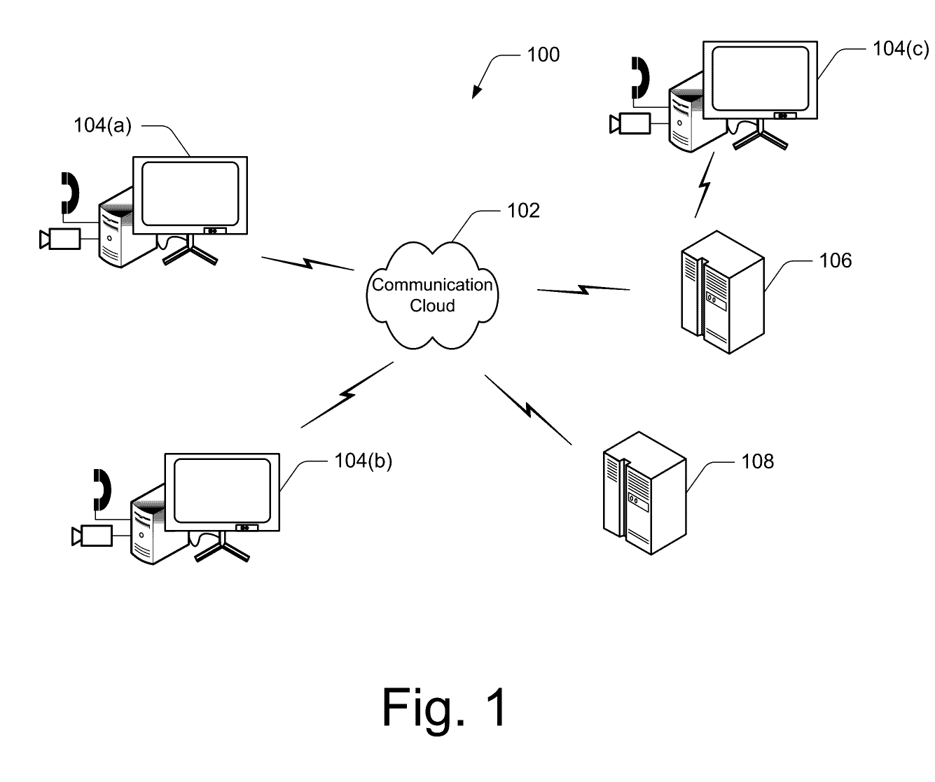

FIG. 1 is a schematic illustration of a communication system 100 which, in at least some embodiments, can be implemented over a communication network, represented here by communication cloud 102 in the form of packet-based Internet, comprising a plurality of interconnected elements. In this example, each network element may be connected to the rest of the Internet, and is configured to communicate data with other such elements over the Internet by transmitting and receiving data in the form of Internet Protocol (IP) packets. Alternately or additionally, networks other than the Internet can be utilized, such as a cellular wireless network. Calling can take place within private networks rather than the Internet. In at least some embodiments, each element also has an associated IP address locating it within the Internet, and each packet includes a source and destination IP address in its header. The elements shown in FIG. 1 include a plurality of end-user terminals 104(a), 104(b), and 104(c) such as desktop or laptop PCs or Internet-enabled mobile phones, a server 106, such as a peer-to-peer server of an Internet-based communication system or a traditional server configured to enable client/server communication, and server 108 that supports or otherwise implements training and/or classification routines, as further described below. However, it will of course be appreciated that many more elements make up the Internet than those explicitly shown. This is represented schematically in FIG. 1 by the communications cloud 102 which typically includes many other end-user terminals, servers and gateways, as well as routers of Internet service providers (ISPs) and Internet backbone routers.

In the illustrated and described embodiment, end-user terminals 104(a) to 104(c) can communicate with one another, as well as other entities, by way of the communication cloud using any suitable techniques. Thus, end-user terminals can communicate through communication cloud 102 using, for example Voice over Internet Protocol (VoIP). Here, end-user terminals 104(a) to 104(c) are illustrated as including video and audio capabilities that can be used as part of the communication exchanges with one another through communication cloud 102.

In at least some instances, in order to communicate with another end user terminal, a client executing on an initiating end user terminal acquires the IP address of the terminal on which another client is installed. This can be done using an address look-up or any suitable technique.

Some Internet-based communication systems are managed by an operator, in that they rely on one or more centralized, operator-run servers for address look-up (not shown). In that case, when one client is to communicate with another, then the initiating client contacts a centralized server run by the system operator to obtain the callee's IP address. Other approaches can be utilized. For example, in some server-based systems, call requests are received by the server and media is relayed by the server. In this instance, there is not an end-to-end connection between the clients, but rather a server in between for the communication that takes place.

In contrast to these operator managed systems, another type of Internet-based communication system is known as a “peer-to-peer” (P2P) system. Peer-to-peer (P2P) systems typically devolve responsibility away from centralized operator servers and into the end-users' own terminals. This means that responsibility for address look-up is devolved to end-user terminals like those labeled 104(a) to 104(c). Each end user terminal can run a P2P client application, and each such terminal forms a node of the P2P system. P2P address look-up works by distributing a database of IP addresses amongst some of the end user nodes. The database is a list which maps the usernames of all online or recently online users to the relevant IP addresses, such that the IP address can be determined given the username. The above constitutes but an example only. It is to be appreciated and understood that other approaches can be utilized without departing from the spirit and scope of the claimed subject matter. For example, some systems can utilize multiple IP addresses or utilize URIs which have DNS names. Once known, the address allows a user to establish a voice or video call, or send an instant message (IM) chat message or file transfer, etc. Additionally however, the address may also be used when the client itself needs to autonomously communicate information with another client.

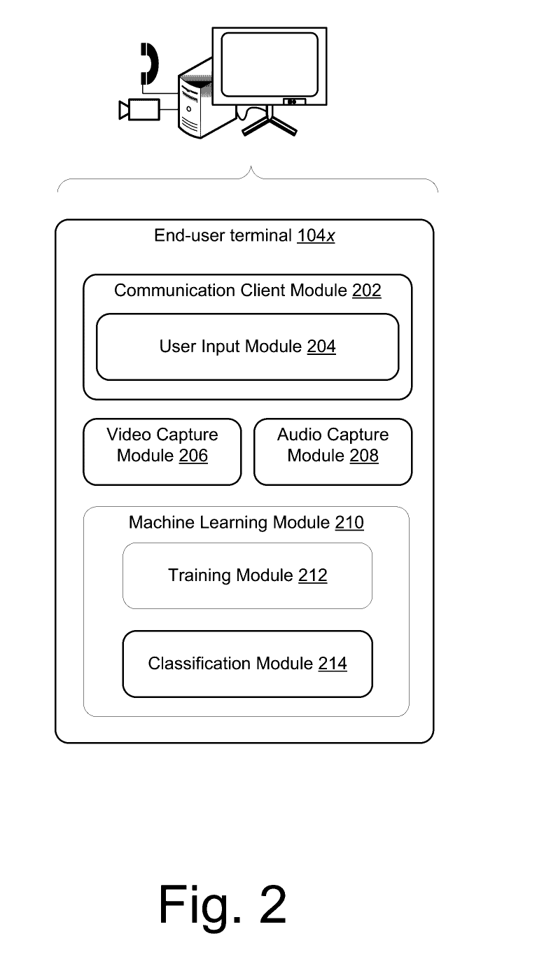

FIG. 2 shows a more detailed example of end-user terminal 104x illustrated in FIG. 1. Here, “x” is used to generically denote that end-user terminal 104x could be any of the end-user terminals illustrated in FIG. 1 (e.g. 104a, 104b, and/or 104c). While end user terminal 104x includes more details than the end-user terminals illustrated in FIG. 1, it is to be appreciated and understood that this illustration is not intended to limit the various configurations of an end user terminal as only including the elements explicitly shown. In other words, various embodiments of an end-user terminal can include more modules and/or functionality than that illustrated in FIG. 2. It is additionally to be appreciated that while end-user terminal 104x is illustrated here as a desktop computer attached to a monitor, an end-user terminal can be any other suitable type of device, examples of which are provided below.

End-user terminal 104x includes communication client module 202. Among other things, communication client module 202 facilitates communication exchanges between end-user terminal 104x and other end-user terminals, as further discussed above. This can include any suitable type of communication exchange, such as a video and/or audio call. User input module 204 allows a user to control at least some of the actions performed by communication client module 202 by providing various forms of input mechanisms. For example, in some cases, user input module 204 displays a user interface containing selectable control(s) that direct what actions to perform when activated. Alternately or additionally, user input module 204 enables keyboard input mechanism(s) into communication client module 202. In at least one embodiment, user input module 204 includes an input mechanism that enables a user to manually capture part of a communication exchange that is subsequently used to train a machine-learning algorithm as further discussed below.

End-user terminal 104x also includes video capture module 206 and audio capture module 208. Video capture module 206 represents functionality that captures a series of images (i.e. video), such as through the use of a camera lens focused on a surrounding environment within visible range of end-user terminal 104x. Audio capture module 208 represents functionality that captures sounds within audible range of end-user terminal 104x, such as through the use of a microphone. In some cases, the captured video and/or captured audio are formatted and/or stored in digital format(s). These captures can be synchronized (e.g. video with corresponding audio) or independent from one another. Here, communication client module 202 interfaces with video capture module 206, audio capture module 208, and/or their respective output(s) for use in a communication exchange. In some embodiments, communication client module 202 automatically triggers a video and/or audio capture. Alternately or additionally, a user can manually trigger a video and/or audio capture through input mechanism(s) provided by user input module 204. While FIG. 2 illustrates end-user terminal 104x as including both a video capture module and an audio capture module, it is to be appreciated that some embodiments can include one or the other without departing from the scope of the claimed subject matter.

End-user terminal 104x also includes machine learning module 210. Among other things, machine learning module 210 can construct algorithm(s) that learn from input data, and apply these constructed algorithms to identify points of interest in a communication exchange. This functionality is further represented by training module 212 and classification module 214. While illustrated here as residing separately from communication client module 202, it is to be appreciated that this is merely for discussion purposes, and the functionality described with respect to machine learning module 210 can alternately be incorporated into communication client module 202.

Training module 212 receives multiple inputs, such as a video and/or audio captures, and analyzes the inputs to identify characteristics contained within the associated content. The identified characteristics are then used train the machine-learning algorithm(s). Any suitable type of characteristic can be identified such as, by way of example and not of limitation, audio and/or video characteristics (key words, facial expressions, voice inflections, movement, turn-taking, and so forth). For instance, input audio capture(s) can be analyzed to train a machine-learning algorithm to identify and/or recognize the sounds contained within the particular input. Alternately or additionally, input video capture(s) can be analyzed to train a machine-learning algorithm to subsequently identify and/or recognize facial expressions. It is to be appreciated that these examples are merely for discussion purposes, and that any other suitable type of characteristics can be learned and/or analyzed. In some cases, the machine-learning algorithm can be trained to perform Automatic Speech Recognition (ASR).

Classification module 214 analyzes input(s) to classify whether the input(s) contain the characteristics identified and/or learned by training module 212. In some embodiments, classification module 214 analyzes real-time communication exchanges, such as those facilitated by communication client 202. As classification module 214 analyzes these exchanges, portions of the exchange can be simply classified as either “containing a characteristic” or “not containing a characteristic”. For instance, the classification module 214 can be configured as a binary classifier that classifies input as falling into one of two groups. In some cases, when a portion of the exchange is classified as “containing a characteristic”, some embodiments auto-trigger a capture of the exchange, as further described below.

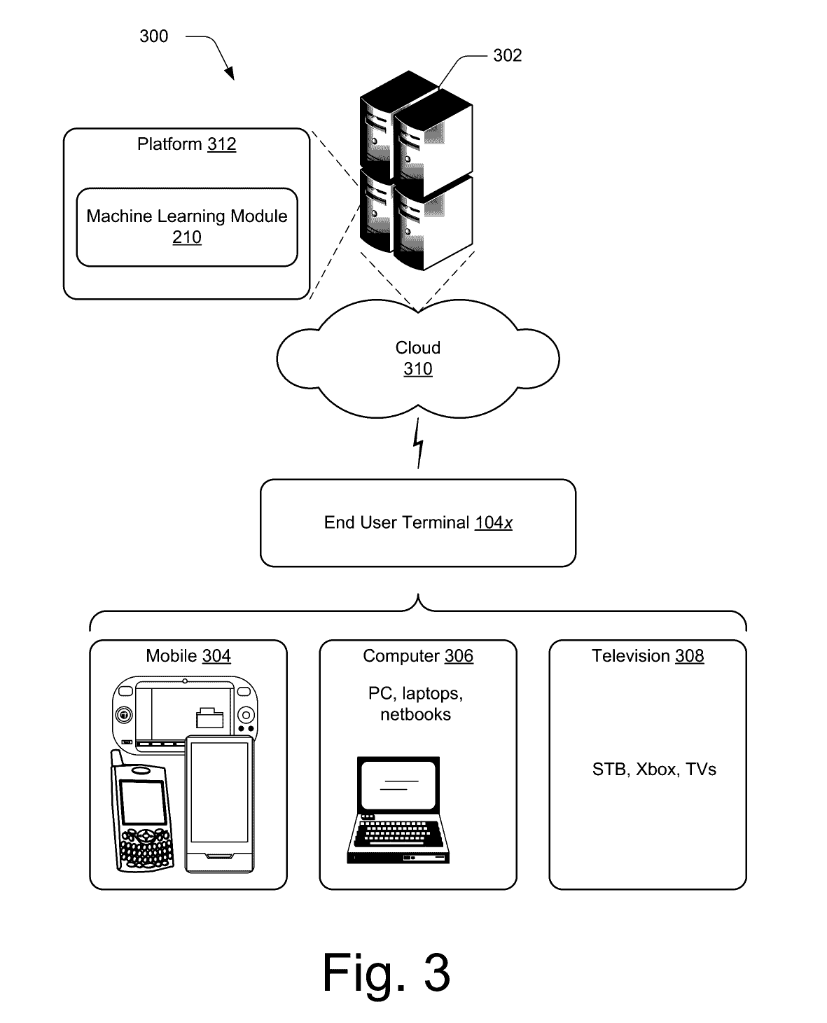

While FIG. 2 illustrates end-user terminal 104x as including machine learning module 210, some embodiments incorporate a machine learning module on a server. For example, consider FIG. 3. FIG. 3 illustrates an example system 300 generally showing server(s) 302 and end-user terminal 104x as being implemented in an environment where multiple devices are interconnected through a central computing device. In some embodiments, server(s) 302 can include server 108 and/or server 106 of FIG. 1. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to that specific class of devices. A class of device may be defined by physical features or usage or other common characteristics of the devices. For example, as previously described, end-user terminal 104x may be configured in a variety of different ways, such as for mobile 304, computer 306, and television 308 uses. Each of these configurations has a generally corresponding screen size and thus end-user terminal 104x may be configured as one of these device classes in this example system 300. For instance, the end-user terminal 104x may assume the mobile 304 class of device which includes mobile telephones, music players, game devices, and so on. The end-user terminal 104x may also assume a computer 306 class of device that includes personal computers, laptop computers, netbooks, tablet computers, and so on. The television 308 configuration includes configurations of device that involve display in a casual environment, e.g., televisions, set-top boxes, game consoles, and so on. Thus, the techniques described herein may be supported by these various configurations of the end-user terminal 104x and are not limited to the specific examples described in the following sections.

In some embodiments, server(s) 302 include “cloud” functionality. Here, cloud 310 is illustrated as including a platform 312 for machine learning module 210. The platform 312 abstracts underlying functionality of hardware (e.g., servers) and software resources of the cloud 310 and thus may act as a “cloud operating system.” For example, the platform 312 may abstract resources to connect end-user terminal 104x with other computing devices. The platform 312 may also serve to abstract scaling of resources to provide a corresponding level of scale to encountered demand for machine learning module 210 that are implemented via the platform 312. A variety of other examples are also contemplated, such as load balancing of servers in a server farm, protection against malicious parties (e.g., spam, viruses, and other malware), and so on. Thus, the cloud 310 is included as a part of the strategy that pertains to software and hardware resources that are made available to the end-user terminal 104x via the Internet or other networks.

Alternately or additionally, servers 302 include machine learning module 210 as described above and below. In some embodiments, platform 312 and machine learning module 210 can reside on a same set of servers, while in other embodiments they reside on separate servers. Here, machine learning module 210 is illustrated as utilizing functionality provided by cloud 310 for interconnectivity with end-user terminal 104x.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features described below are platform-independent, meaning that the techniques may be implemented on a variety of commercial computing platforms having a variety of processors.

Having described example operating environments in which various embodiments can be utilized, consider now a discussion of training machine-learning algorithm(s) in accordance with one or more embodiments.

Training Phase of a Machine Learning Module

Real-time audio and/or video exchanges between participants remote from one another allow the participants to engage in a manner similar to a face-to-face conversation. Certain moments may arise during the exchanges that are significant enough for a participant to want to preserve. However, the moments can sometimes occur and pass too quickly for the participant to manually trigger its capture. To avoid missing a moment, the entire exchange can be captured, but this results in a large volume of data, which can make it difficult for a user to scan through to find the moments of interest, store, or share with others.

Some embodiments automatically capture audio and/or video during a communication exchange between participants, such as during a VoIP call. At times, the automatic capture can be triggered when one or more characteristics are identified and/or observed during the communication exchange. To avoid a false automatic trigger, and help automatically trigger on desired content, a user can train machine-learning algorithm(s) on which characteristics are considered desirable by providing example inputs.

Among other things, a machine-learning algorithm refers to an algorithm that can learn from data. As the algorithm is exposed to data, it can “learn” from it and adapt its subsequent behavior from its “learning”. This differs from traditional predefined programming, where the algorithm programming steps are explicit and repeat the same steps given the same input (i.e. given input A, a predefined algorithm will always yield result X). Machine-learning algorithms have an ability to modify behavior their behavior based upon the data they receive and learn from. For example, the first time a machine-learning algorithm is given an input “A”, it may yield result “X”. However, it is plausible that the next time it is given input “A”, the machine-learning algorithm will yield a different result, such as result “Y”. In some cases, the machine-learning algorithm receives additional data between the two input “A” s that it learns from and adapts to (or learns from the first input “A”). Based upon this additional data, the machine-learning algorithm then adapts its actions. In some embodiments, the machine-learning algorithm can use a form of statistical analysis of an input to model its subsequent behavior. Alternately or additionally, a machine-learning algorithm can be given example inputs, either with or without any desired results, to learn how to map the input to the desired result. These example inputs can be considered a “ground truth” approach, where the example inputs are considered to a baseline for desired content.

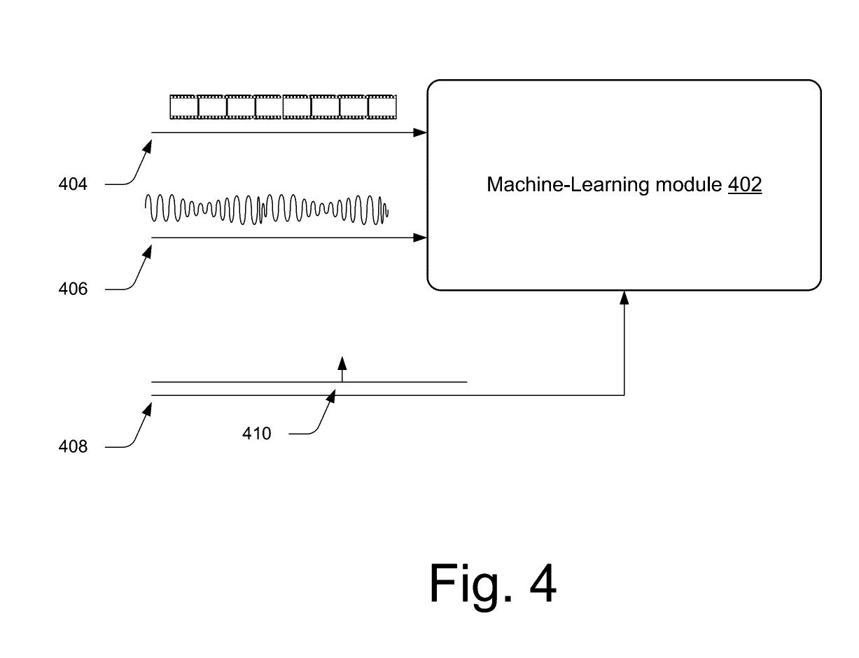

To further illustrate, consider FIG. 4. FIG. 4 shows an example implementation of machine-learning module 402. In some cases, machine-learning module 402 is machine-learning module 210 of FIG. 2 which is illustrated as including training module 212. Here, machine-learning module 402 is illustrated as receiving three inputs: video input 404, audio input 406, and user trigger event(s) input 408. Video input 404 represents a series of images that are ordered in chronological order, while audio input 436 represents an audio signal similarly ordered. These inputs can be formatted in any suitable manner, such as one or more digital formats. While the video and audio are illustrated in FIG. 4 as separate inputs, it is to be appreciated that they can be received together in a unified format (e.g. together), separately, or one without the other. In some cases, the images and/or audio can be time-stamped. These images and audio can correspond to one another, where the audio is the complementary sound to the video images, or they can be independent from one another.

User-triggered event input 408 represents data that is used by machine-learning module 402 to identify point(s) in time that contain training content. In some embodiments, user input module 204 displays a user interface associated with communication client 202 that contains a selectable trigger control, where activation of the selectable trigger control sends a user-triggered event to machine-learning module 402. Alternately or additionally, user input module 204 can be configured to receive keyboard input(s) as an input to activate a user-triggered event, such as a user hitting the space bar, the enter key, a combination or sequence of characters, and so forth. Here, user-triggered event input is represented as an impulse occurring at time 410. While this is illustrated as an impulse, it is to be appreciated that this is merely for discussion purposes, and that user-triggered event can be configured as any suitable type of data (i.e. time stamp information, a physical hardware trigger, etc.). Time 410 corresponds to a point in time associated with the user initiating a training capture, but it is to be further appreciated that there may be delay in when the user activates the trigger, and when its associated point in time is registered. In some cases, the user-triggered event simply includes a single time stamp which is then used to derive a capture window. Alternately or additionally, user-triggered event includes multiple time stamps that can be used to deprive a starting time and a stop time for a capture window.

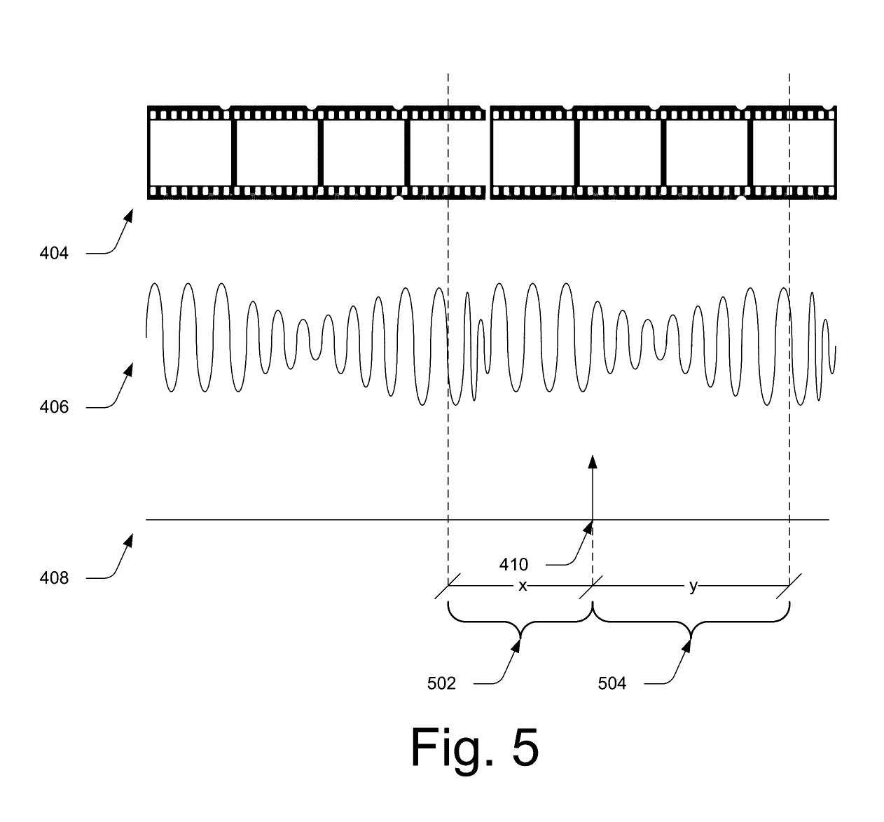

Consider now an example of a training clip capture illustrated in FIG. 5. Aspects of the described capture can be implemented in any suitable manner, such through communication client module 202 and/or machine learning module 210 embodied on end-user terminal 104x and/or server(s) 302. Here, the training clip includes data extracted from video input 404 and audio input 406 of FIG. 4. At time 410, a user initiates a training capture. This can be done in any suitable manner, examples of which are provided above. When the user-trigger event is received at time 410, some embodiments use the event, and/or information contained within the event input, to determine how to capture the corresponding video and audio. In this example, the training clip includes some data capture prior to time 410, and some data capture after time 410 (illustrated here as capture times 502 and 504, respectively). However, it is to be appreciated that data can be captured in any suitable manner, such as capturing all of the training clip using data all prior to the event, using data all after the event, using two events to determine a capture window, and so forth. In order to capture data prior to time 410, some embodiments use a circular buffer that holds a predefined amount of data. When writing data into a circular buffer, writes wrap around to the beginning of the buffer when the end has been reached, and oldest data is overwritten with new data. This allows for preservation of at least some past history of the captured data, thus enabling data capture prior to a trigger-event. While this discussion uses time as a reference point, this is merely for discussion purposes, and it is to be appreciated that any other suitable type of time reference data can be utilized without departing from the scope of the claimed subject matter, such as array index references, time-stamps, and so forth. Here, the lengths of capture times 502 and 504 are generically given the values of x and y to indicate their arbitrary nature. These values can either be predefined values that are accessible by a machine-learning module, and/or values that are included in the user-triggered event.

Once the training clip has been captured, a training module, such as training module 212 of FIG. 2, analyzes the data to learn its characteristic(s). The analysis can occur in “real-time” (i.e. during the communication exchange in which the training clip was captured) and/or can occur “offline” (i.e. at a point later in time after completion of the communication exchange). Any suitable type of characteristic can be learned such as, by way of example and not of limitation, sound level identification, turn-taking between multiple participants, light intensity variation, expression identification, voice inflection change identification, video and/or audio quality, and so forth. While the discussion above used the context of one training capture from one user as input, it is to be appreciated that the training module can receive a plurality of training capture inputs from a plurality of participants, each in a respective (and independent) communication exchange, or capture each participant user input that are joined in a same communication exchange with one another when a user-triggered event occurs. Referring back to FIG. 3, when machine learning module 210 resides on server(s) 302, multiple end-user terminals can submit multiple training clips for the training module to subsequently analyze. The results of these multiple analyses can then be aggregated together to further refine what the machine-learning algorithm learns. Alternately or additionally, each user can log onto server(s) 302 with a private account and personalize the machine-learning module to isolate their training clips from other users so that different learned algorithms are applied to different users.

One advantage to user-triggered events that captured training clips is that it allows user(s) to define and teach the machine-learning algorithm(s) what characteristics are of interest to the user(s). For instance, instead of using a predefined facial recognition algorithm, such as a smile recognition algorithm that identifies characteristics associated with a smile, a user can instead teach the machine-learning algorithm(s) to identify characteristics associated with a frown, their name being spoken, when a face comes on screen, a project or customer name for a corporation, a particular face, and so forth. Thus, the user can personalize and tailor the machine-learning algorithm(s) to their interest(s).

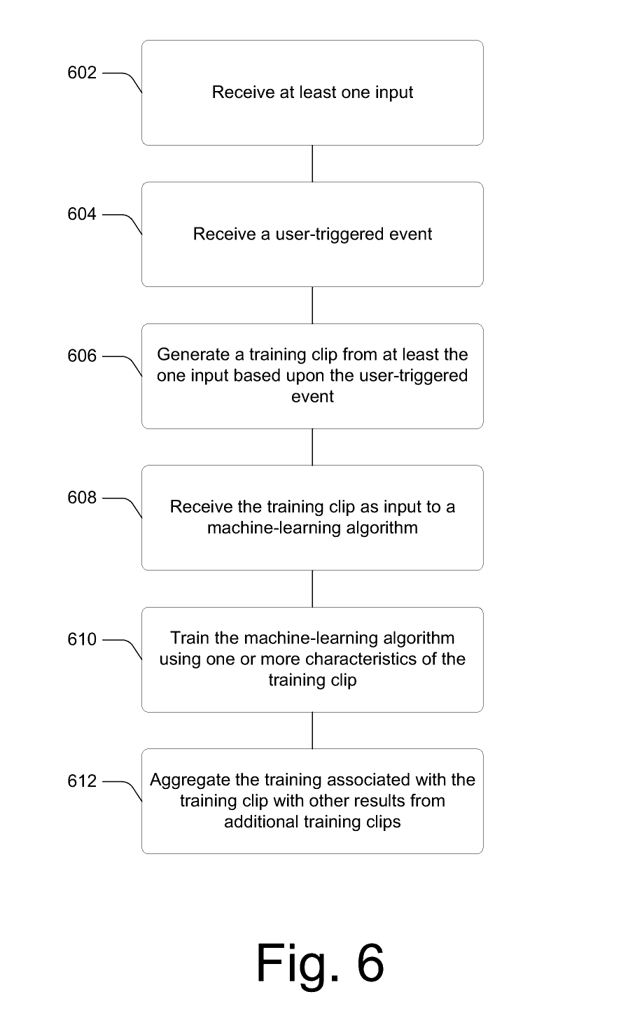

Now consider FIG. 6, which is a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as machine-learning module 210, training module 212, and communication client module 202 of FIG. 2, machine-learning module 402 of FIG. 4, and/or any combination thereof.

Step 602 receives at least one input, such as an audio and/or video input. These inputs can be received in any suitable format and manner, as discussed above. In some cases, the inputs include additional data, such as timestamps, metadata, and so forth. Some embodiments receive audio and video input at a communication client as part of a communication exchange between participants, such as a VoIP call. Alternately or additionally, the input(s) can be received outside of a communication exchange, such as a user simply capturing audio and/or video for the sake of capturing their surroundings, themselves, etc. At times, the received audio and/or video input(s) originate from at least one remote participant in a call. Alternately or additionally, the received audio and/or video input(s) originate from a microphone or camera local to a device.

Step 604 receives a user-triggered event. Among other things, a user-triggered event corresponds to a user manually selecting a control or entering input, such as through a selectable control on a displayed user interface, pressing a key on a keyboard, touching a touch-screen, performing a gesture on a touch-screen, and so forth. The user-triggered event can be received in any suitable manner, and include any suitable type of information. For example, a user-triggered event can be a processor interrupt, a software event, a software semaphore transaction, a message in a software queue, protocol handshakes between multiple threads, and so forth. Alternately or additionally, the user-triggered event can include various types of information, such as time stamp information, capture length, user identification information, call identification information, address information, and so forth.

Responsive to receiving a user-triggered event, step 606 generates a training clip from at least the one input based upon the user-triggered event. The training clip can sometimes be an excerpt and/or extracted portion of audio and video input(s). For example, audio and video can be continuously captured in a circular buffer. An incoming user-triggered event can identify a capture point the within the circular buffer, and a training clip can subsequently be extracted based upon the identified capture point. Some embodiments generate the training clip by extracting some data prior to the identified capture point and some data after the identified capture point. The length of the training clip can be determined in any suitable manner, such as through information included as part of the user-triggered event, through a user defined parameter, through a predefined length, and so forth. Some embodiments add identifying information to the training clip, such as user identification, origination information, etch. Other embodiments strip any identifying information from the training clip to maintain anonymity.

Step 608 receives the training clip as input to a machine-learning algorithm. Any suitable type of machine-learning algorithm can be utilized, such as machine-learning algorithms based upon, by way of example and not of limitation, supervised learning, unsupervised learning, reinforcement learning, neural network learning, inductive logic programming, Gaussian process regression, decision trees, linear classifiers, vector quantization, cluster analysis, temporal difference learning, outlier detection, and so forth. Responsive to receiving the training clip, step 610 trains the machine-learning algorithm using one or more characteristics of the training clip. For example, the machine-learning algorithm can be built and/or adapted based upon a statistical analysis of the training clip.

Step 612 aggregates the training associated with the training clip with other results from additional training clips. For instance, in some embodiments, the machine-learning algorithm uses multiple inputs to continuously refine and modify a resultant algorithm and/or actions that are executed, instead of simply purging results from previous inputs. In some embodiment, the machine-learning algorithm aggregates multiple inputs of various origins (i.e. multiple users, multiple capture devices, etc.).

Having considered training a machine-learning algorithm through user-triggered training clips, consider now a discussion of how a machine-learning algorithm can be used to automatically trigger data capture.

Capture of Key Moments in Communication Exchanges

As discussed above, a machine-learning algorithm can be trained by one or more users to learn characteristic(s) of multiple inputs. In at least some embodiments, user input that is used to train the machine-learning algorithm defines, for the algorithm, a “ground-truth” on what is desirable by the user, as further discussed above. In turn, the learned characteristic(s) can be applied to a real-time communication exchange between users to identify points of interest. Alternately or additionally, predefined characteristics can be used to identify points of interest, as further described below. When one or more characteristics are identified in the communication exchange, some embodiments trigger an automatic capture of the communication exchange.

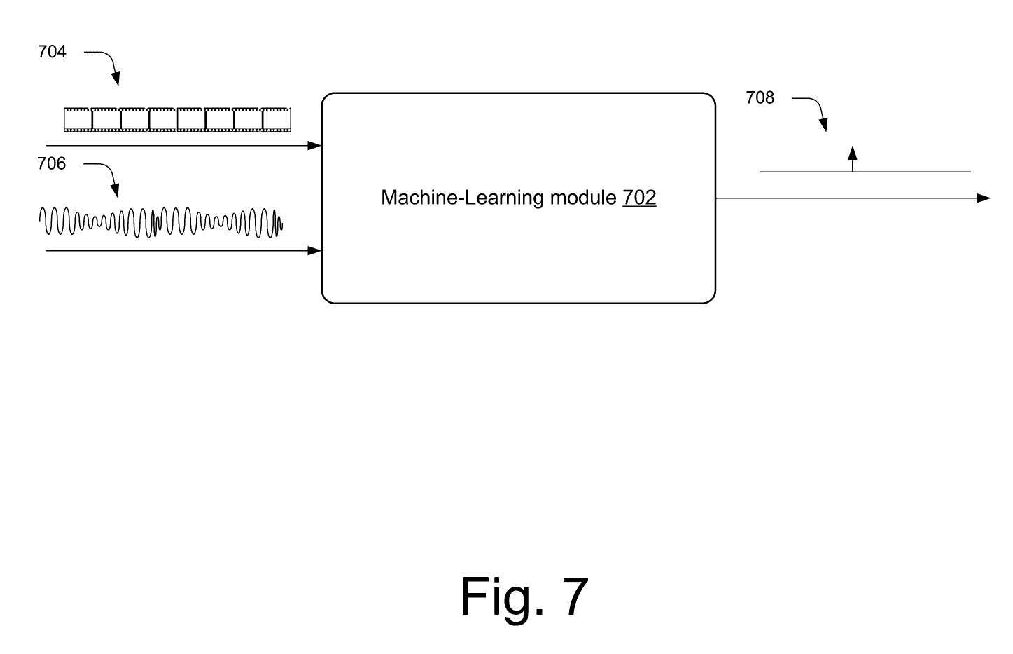

Consider FIG. 7, which shows an example implementation of a machine-learning module 702 employed during a communication exchange. In some cases, machine-learning module 702 can be machine-learning module 402 of FIG. 4 and/or machine-learning module 210 of FIG. 2 that includes classification module 214. Here, machine-learning module 702 receives real-time inputs associated with a communication exchange: video input 704 and audio input 706. The term “real-time” indicates that the input is received without perceptible delay from when it was generated, and is received in a continuous flow. While the system may introduce some delay between when the input was generated to when it is received and consumed, the system delay is not significant enough to disrupt the communication exchange. Video input 704 and/or audio input 706 can simply be input from one participant in the communication exchange, multiple inputs from various participants in the communication exchange, and/or a mixed version of video and audio from a server that mixes inputs from multiple participants. At times, the communication exchange is facilitated by a communication client, such as communication client module 202 of FIG. 2. Further, while this discussion refers to a classification process that occurs during a real-time communication exchange, it is to be appreciated that the various techniques discussed can easily be employed in other manners. For instance, some embodiments classify inputs offline and/or outside of a communication exchange (i.e. classifying stored audio and/or video inputs at a later point in time from when they were captured).

Among other things, machine-learning module 702 analyzes the input(s) in real-time as they are received to search for characteristic(s). Any suitable characteristic, or combination of characteristics, can be searched for. These characteristics can be “learned” characteristics (such as characteristics learned by machine learning algorithm(s) via training module 212 of FIG. 2) or predefined characteristics. One example of a predefined characteristic is the notion of “turn-taking”. When multiple people engage with each other verbally, ideas can sometimes flow rapidly. As one person suggests an idea, another person may chime in quickly after the suggestion to give their opinion, and so forth. This rapid succession of “turn-taking” can be identified using predefined characteristic(s). Some embodiments use a predefined measure of time between when different participants speak as a threshold or gauge to identify when a rapid succession of turn-taking is occurring. For instance, a communication exchange can be analyzed to identify when the turn-taking between participants is approaching (or passing) the predefined threshold. Alternately or additionally, turn-taking can be measured with other metrics, such as a count of how many switches between participants happen per second, duration between participants, duration of new-speaker utterances, or any suitable type of heuristic that spans one or more parameters. Thus, various embodiments can search for predefined characteristics and/or learned characteristics, and trigger a capture when these characteristics are recognized, as further described above and below.

Some embodiments search for multiple characteristics or “modes” to occur concurrently. For example, consider a case where a machine-learning module has been trained to identify an audio pattern and/or cue associated with the word “wow”, a visual pattern associated with a smile, and a predefined audio quality metric. As discussed above, the machine-learning module can be configured to search for simply one of these modes (i.e. identifying when “wow” is spoken, identify a smile facial expression, identify when the audio quality is at a certain level, etc.). Alternately or additionally, the machine-learning module can be configured to search for the occurrence of multiple modes simultaneously (i.e. identify when a “wow” occurs concurrently with a smile, identify when a “wow” occurs concurrently with a predefined audio quality, identify when a “wow” and smile occur concurrently at a predefined audio quality, etc.). Thus, a machine-learning module can identify single modes at a time, or identify multiple modes that occur concurrently.

In some cases, the machine-learning module changes what characteristics it searches for and/or how it classifies them based upon the environment it is operating in. For example, if the inputs pertain to a communication exchange in an enterprise environment, some embodiments alter the classification process to look for characteristic(s) that pertain to multiple participants, or use characteristic(s) defined by the associated organization. When the “enterprise characteristic(s)” are observed, then machine-learning module 702 classifies the inputs as being desirable. However, in a single-user environment, the machine-learning module instead searches for characteristic(s) defined by the user, and only classifies an input as desirable when the user-defined characteristics occur. For example, in a single-user environment, the machine-learning module may be configured to search for the term “wow”, as further discussed above. However, when the machine-learning module switches to an enterprise environment, it may no longer search for the “wow”, and instead search for a project name being spoken. Thus, the machine-learning module can change based upon its operating environment. When an input has been classified as desirable, machine-learning module 702 triggers an event or capture of the input.

Capture trigger event 708 represents a trigger and/or event associated with capturing at least a portion of an input, such as input 704 and/or audio input. When the classification module identifies moments in the input(s) that include the learned characteristic(s) and/or predefined characteristic(s), an automatic trigger and/or event is generated without user intervention to generate the trigger. In other words, the capture trigger event is generated based up the identification of the characteristic(s), and not by the user selecting to generate a capture trigger event. FIG. 7 illustrates capture trigger event 708 as an impulse. However, similar to trigger event input(s) 408 of FIG. 4, this is merely for discussion purposes, and can be configured in any suitable manner without departing from the scope of the claimed subject matter. In some embodiments, a capture trigger event initiates a capture of the input(s) similar to that described with respect to FIG. 5 above (i.e. pre-and-post trigger capture, all post-trigger capture, all pre-trigger capture, etc.). These captures can include inputs from all participants in an associated communication call, a user-defined selection of participants in the associated communication call, only on participant in the communication call, etc., and can be configured in any suitable manner. Some captures simply take a single image capture, while others take a series of images (i.e. video). The corresponding sound can also be captured, or simply the sound can be captured without any images. The duration and length of the capture can be determined in any suitable manner, examples of which are provided above. Some communication clients additionally allow for display of documentation and/or user annotations between participants during a communication exchange. In these cases, some embodiments capture of the display screen to preserve what is being displayed or shared between the participants.

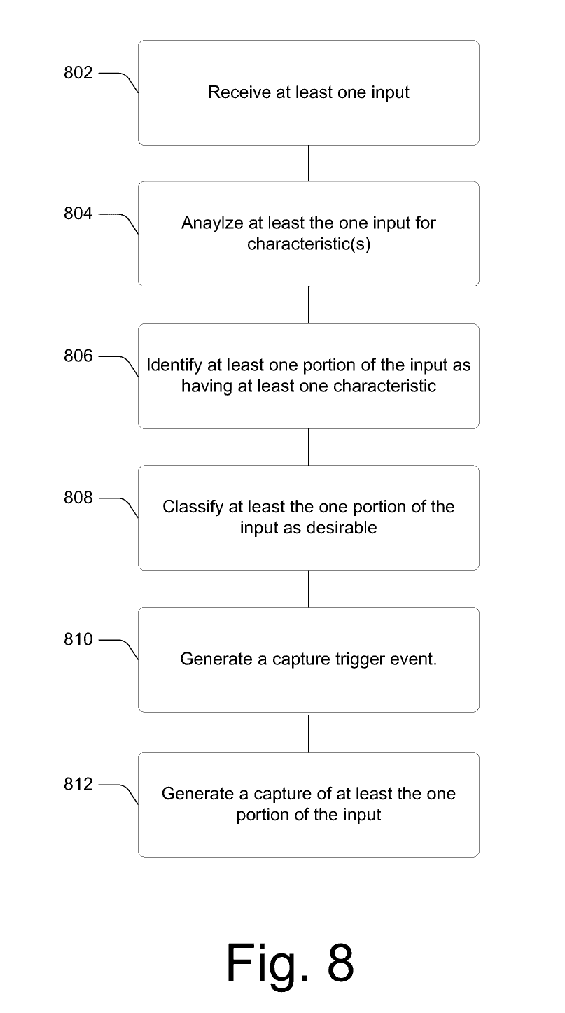

Now consider FIG. 8, which is a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as machine-learning module 210, training module 212, and communication client module 202 of FIG. 2, machine-learning module 702 of FIG. 7, and/or any combination thereof.

Step 802 receives at least one input. In some embodiments, the input corresponds to real-time audio and/or video associated with a communication exchange. The input can be audio and video associated with one participant in the communication exchange, or multiple participants in the communication exchange. These inputs can originate from input devices local to a computing device (i.e. a local camera and microphone), or can alternately originate from remote participants.

Responsive to receiving at least one input, step 804 analyzes at least the one input for one or more characteristic(s). In some cases, the input is analyzed using a machine-learning algorithm that was trained to identify points of interest in the input, examples of which are provided above. Alternately or additionally, the input is analyzed for predefined characteristics. In some cases, single characteristics (e.g. single-modal) are searched for, while in others, combinations (e.g. multi-modal) are searched for. As part of the analysis, step 806 identifies at least one portion of the input as having at least one characteristic.

Responsive to identifying a portion of the input as having at least one characteristic, step 808 classifies at least the one portion of the input as desirable. For example, some embodiments employ a binary classifier that simply classifies each portion of an input as being either desirable, or undesirable. In some cases, the output of the binary classifier can be “smoothed”. For example, if the binary classifier determines multiple desirable portions in a predetermined window size (i.e. 15 desirable portions in a 1 second window of input), the multiple portions can be grouped together, or coalesced, into one identifiable portion that captures a superset of a range that contains each desirable portion.

Responsive to the input being classified as desirable, step 810 generates a capture trigger event. Any suitable type of mechanism can be used to generate a capture trigger event, such as a hardware interrupt, a software interrupt, a software event, a software semaphore, a messaging queue, and so forth. In some cases, the capture trigger event can include additional information, such as a communication exchange identifier, a time-stamp, a capture length, etc. Step 812 generates a capture of at least the one portion of the input based, at least in part, on the capture trigger event. As further discussed above, the capture can include an audio clip from one or more participants of the communication exchange, a video clip from the one or more participants, a screen capture associated with the communication exchange, etc.

Thus, various embodiments automatically capture key moments in a communication exchange based, at least in part, on a user training machine-learning algorithm(s) to identify points of interest. Simple classifiers, such as binary classifiers, can be used to generate a notification when an input includes characteristic(s) of interest. In some cases, a user may want to tailor how many automatic triggers are generated over the lifespan of a communication exchange. Some embodiments additionally provide user settings that give a user additional control over the training and/or automatic capture, such as how many automatic captures are generated in an exchange, grouping characteristics for multi-modal recognition, scheduling playback of the captured inputs, location storing of the captured inputs, maintaining associations of the captured inputs (i.e. with particular users, projects, etc.), and so forth. These automatic captures provide the user with key moments of a communication exchange, instead of the whole exchange. This provides more efficient memory usage to the user, as well as more reliable capture of the key moments than manual moments that are prone to human error.

Having considered the classification of desirable input based, at least in part, upon machine-learning algorithm(s), consider now a discussion of implementation examples that employ the techniques described above.

Example System and Device

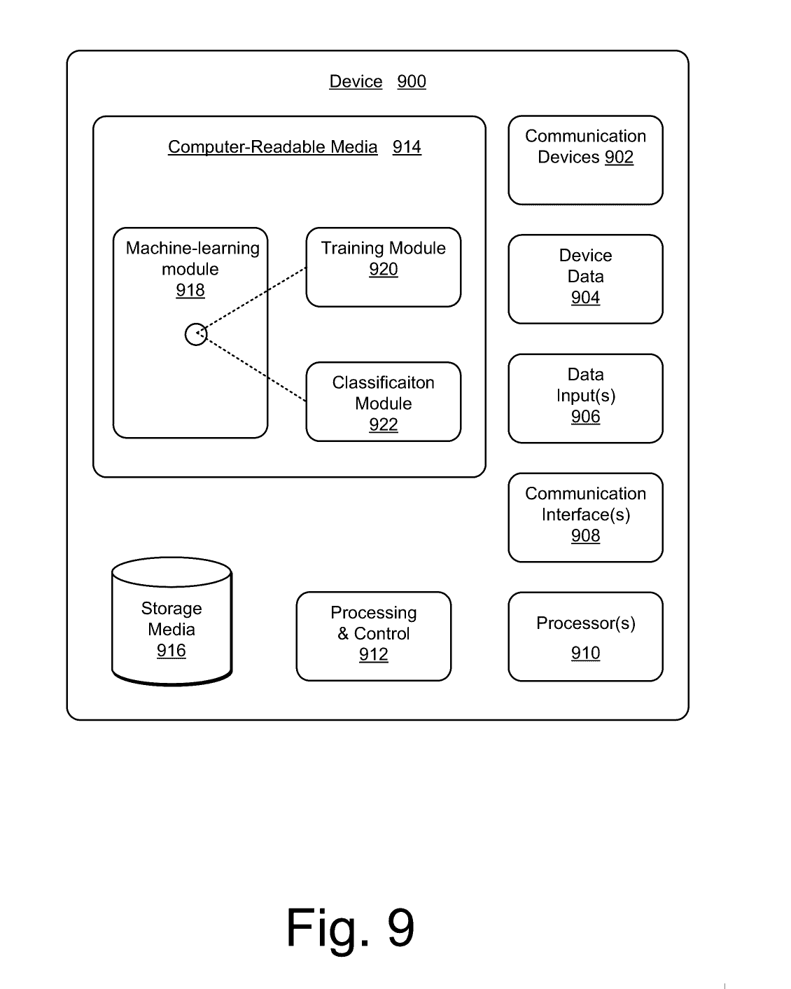

FIG. 9 illustrates various components of example device 900 that can be implemented as any type of computing device as described with reference to FIGS. 1-3 to implement embodiments of the techniques described herein. Device 900 is illustrative of an example device, such as end-user terminal 104x of FIGS. 1-3, and/or server(s) 302 of FIG. 3.

Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 916.

Computer-readable media 914 provides data storage mechanisms to store the device data 904, as well as machine-learning module 918 and any other types of information, applications, and/or data related to operational aspects of device 900. Here, machine-learning module 918 includes training module 920 and classification module 922. Machine-learning module 918 can be maintained as a computer application with the computer-readable media 914 and executed on processors 910. Machine-learning module 918 can also include any system components or modules to implement embodiments of the techniques described herein. While not illustrated here, it is to be appreciated that, in some embodiments, machine-learning module 918 can be a sub-module of, or have close interactions with, a communication client, such as communication client 202 of FIG. 2.

Training module 920 includes at least one machine-learning algorithm. Among other things, training module 920 receives user-triggered inputs to analyze and learn from. In some cases, the input includes a real-time audio and/or video input that a training clip is subsequently extracted from. At times, training module 920 can adapts its behavior based upon the inputs, as further discussed above. Classification module 922 represents functionality that can receive inputs, such as a real-time audio and/or video input, and analyze the inputs for one or more desired characteristics. When the desired characteristics are identified, classification module 922 can automatically trigger a capture of the inputs over a portion that contains the desired characteristics. While illustrated separately from training module 920 here, other embodiments combine training module 920 and classification module 922. These modules are shown as software modules and/or computer applications. However, these modules can alternately or additionally be implemented as hardware, software, firmware, or any combination thereof.

### CONCLUSION

Various embodiments provide an ability to automatically capture audio and/or video during a communication exchange between participants. At times, the automatic capture can be triggered when one or more characteristics are identified and/or observed during the communication exchange. In some cases, analyzing the communication exchange for characteristic(s) is based on training the analysis with previous input. Some embodiments train a machine-learning algorithm on desired characteristic(s) using multiple user-initiated video and/or audio clips. Alternately or additionally, some embodiments identify characteristic(s) in a communication exchange based on other properties not provided by user-input.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method for training a machine-learning algorithm to identify one or more moments of interest in communication exchanges, the computer-implemented method comprising:
receiving, using the computer, at least one user-triggered training clip associated with a communication exchange as input to the machine-learning algorithm;
training, using the computer, the machine-learning algorithm using one or more characteristics associated with the at least one user-triggered training clip; and
aggregating, using the computer, the training associated with the at least one user-triggered training clip with other results from additional training clips effective to enable automatic capture of one or more moments of interest in the communication exchanges.

2. The computer-implemented method of claim 1, wherein training the machine-learning algorithm further comprises training the machine-learning algorithm at least by using a statistical analysis of the training clip.

3. The computer-implemented method of claim 1 further comprising receiving the training clip, training the machine-learning algorithm, and aggregating the training at a cloud-based service.

4. The computer-implemented method of claim 1, wherein, prior to receiving the training clip, the method further comprises:
receiving, using the computer, at least one input associated with the communication exchange;
receiving, using the computer, a user-triggered event; and
generating, using the computer, the training clip from the at least one input based, at least in part, on the user-triggered event.

5. The computer-implemented method of claim 4, wherein generating the training clip further comprises generating the training clip using data associated with the at least one input captured prior to the user-triggered event and data associated with the at least one input captured after the user-triggered event.

6. The computer-implemented method of claim 4, wherein the at least one input comprises at least:
audio associated with a participant in the communication exchange; or
video associated with the participant in the communication exchange.

7. The computer-implemented method of claim 4, wherein the at least one input comprises timestamp information associated with the at least one input.

8. The computer-implemented method of claim 1, wherein the communication exchange comprises a Voice-over-Internet Protocol (VoIP) communication call.

9. The computer implemented method of claim 4, wherein the at least one input comprises audio and video inputs associated with at least two participants in the communication exchange.

10. A computer-implemented method for automatically capturing at least one moment of interest in a first communication exchange, the method comprising:
receiving, using the computer, at least one input associated with the first communication exchange;
analyzing, using the computer, the at least one input for at least one characteristic;
identifying, using the computer, at least one portion of the at least one input as having the at least one characteristic;
classifying, using the computer, the at least one portion as desirable;
responsive to classifying the at least one portion as being desirable, automatically generating, using the computer, a capture trigger event; and
generating, using the computer, a capture of the at least one portion of the input that is classified as being desirable based, at least in part, on the capture trigger event effective to automatically provide at least one moment of interest to a user.

11. The computer-implemented method of claim 10, wherein classifying the at least on portion as desirable further comprises using a binary classifier for at least part of the classifying.

12. The computer-implemented method of claim 10, wherein the analyzing for at least one characteristic further comprises analyzing for multi-modal characteristics.

13. The computer-implemented method of claim 10, wherein the analyzing for at least one characteristic is based, at least in part, on a machine-learning algorithm that has been trained on user-triggered training clips associated with at least one communication exchange other than the first communication exchange.

14. The computer-implemented method of claim 10, wherein generating the capture of the at least one portion of the input further comprises generating the capture using some data associated with the input captured prior to the capture trigger event and some data associated with the input captured after the capture trigger event.

15. The computer-implemented method of claim 10, wherein the at least one characteristic comprises at least one of:
an audio quality;
a video quality;
a facial expression;
an audio cue associated with a key word; or
a turn-taking metric.

16. A device for automatically capturing a moment of interest in a communication exchange, the device comprising:
a video camera for generating video images;
a microphone for capturing audio sounds;
at least one processor; and
one or more computer-readable storage memories comprising processor instructions which, responsive to execution by at least one processor, are configured to implement, at least in part:
an input module associated with a communication client module configured to receive real-time audio and input generated by the video camera and microphone as part of communication exchanges;
a training module configured to:
receive real-time audio and video input, via the communication client module, associated with at least a first communication exchange;
receive a user-triggered event via the input module;
generate a training clip from the real-time audio and video input based, at least in part, on the user-triggered event, by extracting the training clip from the real-time audio and video input associated with at least the first communication exchange; and
train a machine-learning algorithm using at least the training clip; and
a classification module configured to:
receive real-time audio and video input, via the communication client module, associated with at least a second communication exchange;
analyze the real-time audio and video input associated with at least the second communication exchange for one or more characteristics based, at least in part, on the machine-learning algorithm;
classify the at least one portion of the real-time audio and video input associated with the at least second communication exchange as desirable;
automatically generate a capture trigger event; and
generate a capture of the at least one portion of the input that is classified as being desirable based, at least in part, on the capture trigger event.

17. The device of claim 16, wherein the input module is further configured to generate the user-triggered event based, at least in part, on receiving an input associated with a keyboard input.

18. The device of claim 16, wherein the communication client module comprises a Voice-over-Internet Protocol (VoIP) communication client module.

19. The device of claim 16, wherein the training module is further configured to:
receive a plurality of training clips;
train the machine-learning algorithm using each of the plurality of training clips; and
aggregate each result from each training clip of the plurality of training clips together.

20. The device of claim 16, wherein the classification module is further configure to:
identify single-modal characteristics effective to classify a portion of the real-time audio and video input associated with at least the second communication exchange as desirable; and
identify multi-modal characteristics effective to classify a portion of the real-time audio and video input associated with at least the second communication exchange as desirable.
